(19) United States
(12) Patent Application Publication
(10) Pub. No.: US 2024/0080503 A1
(43) Pub. Date: Mar. 7, 2024

(54) LIVESTREAMING SCHEDULING PROCESSING METHOD AND SYSTEM

(71) Applicant: SHANGHAI BILIBILI TECHNOLOGY CO., LTD., Shanghai (CN)

(72) Inventor: Xuze LU, Shanghai (CN)

(21) Appl. No.: 18/241,750

(22) Filed: Sep. 1, 2023

(30) Foreign Application Priority Data
Sep. 5, 2022 (CN) 202211095061.1

(51) Int. Cl. H04N 21/2187; H04N 21/239; H04N 21/262

(52) U.S. Cl. CPC H04N 21/2187; H04N 21/2393; H04N 21/26208

(57) ABSTRACT

This application discloses techniques for scheduling livestreaming sessions and presenting scheduled livestreaming sessions. The techniques comprise in response to receiving a request for scheduling a livestreaming session sent by a streamer terminal device, causing to display a scheduling setting page on the streamer terminal device; receiving information associated with the livestreaming session to be produced via the scheduling setting page; generating a corresponding scheduling identifier (ID), and associating the information received via the scheduling setting page with the scheduling ID; causing to display an interface element configured to prompt a query for livestreaming scheduling information on an audience terminal device in response to determining that the audience terminal device enters a live room; and in response to receiving a scheduling query request from the audience terminal device, querying scheduling information published by the online streamer and returning the scheduling information to the audience terminal device for rendering and displaying.

### CROSS-REFERENCE TO RELATED APPLICATION

The present application claims priority to Chinese Patent Application No. 202211095061.1, filed on Sep. 5, 2023, which is incorporated herein by reference in its entirety.

### TECHNICAL FIELD

This application relates to the field of livestreaming technologies, and in particular, to a livestreaming scheduling processing method and system, an electronic apparatus, and a computer-readable storage medium.

### BACKGROUND

With popularization and development of livestreaming technologies, there are more online streamers who produce a lot of livestreaming sessions. Therefore, improvements in livestreaming scheduling are needed.

### SUMMARY

A main objective of this application is to provide a livestreaming scheduling processing method and system, an electronic apparatus, and a computer-readable storage medium, to resolve a problem of lack of related information during livestreaming scheduling.

To implement the foregoing objective, an embodiment of this application provides a livestreaming scheduling processing method, applied to a server. The method includes:
when a request for publishing livestreaming scheduling by an streamer terminal device is received, providing a scheduling setting page for live commerce, where the scheduling setting page includes product adding and prize drawing setting;
in response to receiving product information added by the online streamer terminal, associating the product information with the livestreaming scheduling;
in response to receiving prize drawing information set by the online streamer terminal, generating a prize pool based on the prize drawing information, and associating prize pool information with the livestreaming scheduling; and
after a scheduling query request initiated by a user of an audience terminal device in a live room is received, querying scheduling information published by an online streamer in the live room and the associated product information and prize pool information, and returning the scheduling information and the associated product information and prize pool information to the audience terminal device for rendering and displaying.

Optionally, before the providing a scheduling setting page for live commerce, the method further includes:
verifying whether a user of the streamer terminal device has a live commerce permission; and
providing the streamer terminal device with the scheduling setting page when the user of the streamer terminal device has the live commerce permission.

Optionally, the receiving product information added by the streamer terminal device includes:
querying inventory information of products for sale of the user of the online streamer terminal;
providing the streamer terminal device with a product list based on the inventory information; and
receiving products checked by the user of the streamer terminal device in the product list and a check order.

Optionally, the associating the product information with the livestreaming scheduling includes:
recording a mapping relationship among a scheduling ID of the livestreaming scheduling, the scheduling information, and information about the checked products, and writing the mapping relationship into a database, where the product information is recorded in the check order, to be displayed in the check order after being returned to the audience terminal device.

Optionally, the associating the prize pool information with the livestreaming scheduling includes:
recording a mapping relationship between a prize pool ID and the scheduling ID into the database.

Optionally, before the scheduling query request initiated by the user of the audience terminal device in the live room is received, the method further includes:
when the user of the audience terminal device enters the live room, controlling, according to a preset rule, the audience terminal device to display a livestreaming scheduling prompt identifier in the live room.

Optionally, the preset rule includes:
when livestreaming of a current session is product selling livestreaming, the user of the streamer terminal device has the live commerce permission, and livestreaming scheduling for a future session is already published, controlling the audience terminal device to display the livestreaming scheduling prompt identifier in the live room.

Optionally, the querying scheduling information published by an online streamer in the live room and the associated product information and prize pool information further includes:
when the online streamer already publishes livestreaming scheduling for a plurality of sessions, querying scheduling information of livestreaming scheduling for a session specified by the online streamer and associated product information and prize pool information.

In addition, to implement the foregoing objective, an embodiment of this application further provides a livestreaming scheduling processing method, applied to an online streamer terminal. The method includes:
receiving an operation of publishing livestreaming scheduling by a user, and providing the user with a scheduling setting page for live commerce, where the scheduling setting page includes product adding and prize drawing setting;
in response to receiving product information added by the user, sending the product information to a server, to associate the product information with the livestreaming scheduling; and
in response to receiving prize drawing information set by the user, sending the prize drawing information to the server, to generate a prize pool based on the prize drawing information, and associate prize pool information with the livestreaming scheduling.

Optionally, before the providing the user with a scheduling setting page for live commerce, the method further includes:
sending information about the user to the server to verify whether the user has a live commerce permission; and
providing the user with the scheduling setting page when the user has the live commerce permission.

Optionally, the receiving product information added by the user includes:
requesting the server to query inventory information of products for sale of the user;
providing the user with a product list based on the inventory information; and
recording products checked by the user in the product list and a check order.

To implement the foregoing objective, an embodiment of this application further provides a livestreaming scheduling processing method, applied to an audience terminal device. The method includes:
displaying a livestreaming scheduling prompt identifier in a live room according to a preset rule when a user enters the live room;
initiating a scheduling query request to a server when the user triggers scheduling information display in the live room; and
rendering and displaying, to the user, scheduling information published by an online streamer in the live room and associated product information and prize pool information, where the scheduling information and the associated product information and prize pool information are returned by the server.

Optionally, the preset rule includes:
when livestreaming of a current session is product selling livestreaming, the online streamer in the live room has a live commerce permission, and livestreaming scheduling for a future session is already published, displaying the livestreaming scheduling prompt identifier in the live room.

Optionally, the triggering scheduling information display includes:
receiving an operation of tapping the livestreaming scheduling prompt identifier by the user.

Optionally, the triggering scheduling information display further includes the following automatic trigger scenarios:
the user enters the live room for the first time in each session of livestreaming;
the user watches for preset duration for the first time in each session of livestreaming;
the user follows the online streamer in the live room for the first time in each session of livestreaming;
the user forwards the live room for the first time in each session of livestreaming; or
the livestreaming scheduling prompt identifier appears in the live room in real time during each session of livestreaming.

Optionally, the rendering and displaying includes:
rendering and displaying the scheduling information in the live room by using a banner frame, and displaying a corresponding prompt copy based on the associated product information and prize pool information.

Optionally, the rendering and displaying further includes:
when an operation of tapping the prompt copy of the product information or the prize pool information by the user is received, waking up a window container in the live room, and rendering an H5 page, to display a detail page corresponding to the product information or the prize pool information.

To implement the foregoing objective, an embodiment of this application further provides a livestreaming scheduling processing system. The system includes:
a setting means, configured to: when a request for publishing livestreaming scheduling by an streamer terminal device is received, provide a scheduling setting page for live commerce, where the scheduling setting page includes product adding and prize drawing setting;
an association means, configured to: in response to receiving product information added by the online streamer terminal, associate the product information with the livestreaming scheduling, where
the association means is further configured to: in response to receiving prize drawing information set by the online streamer terminal, generate a prize pool based on the prize drawing information, and associate prize pool information with the livestreaming scheduling; and
a query means, configured to: after a scheduling query request initiated by a user of an audience terminal device in a live room is received, query scheduling information published by an online streamer in the live room and the associated product information and prize pool information, and return the scheduling information and the associated product information and prize pool information to the audience terminal device for rendering and displaying.

To implement the foregoing objective, an embodiment of this application further provides an electronic apparatus. The electronic apparatus includes a memory, a processor, and a livestreaming scheduling processing program stored in the memory and capable of running on the processor, where when the livestreaming scheduling processing program is executed by the processor, the foregoing livestreaming scheduling processing method is implemented.

To implement the foregoing objective, an embodiment of this application further provides a computer-readable storage medium. The computer-readable storage medium stores a livestreaming scheduling processing program, and when the livestreaming scheduling processing program is executed by a processor, the foregoing livestreaming scheduling processing method is implemented.

According to the livestreaming scheduling processing method and system, the electronic apparatus, and the computer-readable storage medium that are provided in the embodiments of this application, information about a product for sale of the online streamer can be combined with livestreaming session scheduling, and the prize drawing information for scheduling participation can be further added. In this way, related information is prompted to the user in the live room during livestreaming scheduling, thereby effectively promoting an interest of the user in scheduling a livestreaming session of the online streamer, and increasing a user recall rate.

### BRIEF DESCRIPTION OF DRAWINGS

FIG. 1 is a diagram of an architecture of an application environment for implementing the embodiments of this application.

FIG. 2 is a flowchart of a livestreaming scheduling processing method according to a first embodiment of this application.

FIG. 3 is a schematic diagram of a scheduling setting page according to this application.

FIG. 4 is a schematic diagram of a scheduling product selection page according to this application.

FIG. 5 is a schematic diagram of a scheduling prize setting page according to this application.

FIG. 6 is a schematic diagram of a livestreaming scheduling prompt identifier according to this application.

FIG. 7 is a flowchart of a livestreaming scheduling processing method according to a second embodiment of this application.

FIG. 8 is a flowchart of a livestreaming scheduling processing method according to a third embodiment of this application.

FIG. 9 is a schematic diagram of a live room in which a banner frame is opened according to this application.

FIG. 10 is a schematic diagram of display content of several banner frames in different cases according to this application.

FIG. 11 is a schematic diagram of a detail page of product information according to this application.

FIG. 12 is a schematic diagram of a hardware architecture of an electronic apparatus according to a fourth embodiment of this application.

FIG. 13 is a schematic diagram of means of a livestreaming scheduling processing system according to a fifth embodiment of this application.

### DESCRIPTION OF EMBODIMENTS

To make the objectives, technical solutions, and advantages of this application clearer and more comprehensible, the following further describes this application in detail with reference to the accompanying drawings and the embodiments. It should be understood that the specific embodiments described herein are merely used to explain this application but are not intended to limit this application. All other embodiments obtained by a person of ordinary skill in the art based on the embodiments of this application without creative efforts shall fall within the protection scope of this application.

It should be noted that the descriptions such as “first” and “second” in the embodiments of this application are merely used for description, and shall not be understood as an indication or implication of relative importance or an implicit indication of a quantity of indicated technical features. Therefore, a feature defined with “first” or “second” may explicitly or implicitly include at least one feature. In addition, technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of this application.

For each session of livestreaming in the future, an online streamer can publish a scheduling notification in advance. A user in a live room can schedule a required livestreaming session, to avoid missing livestreaming of this session. However, currently, for scheduling of a livestreaming session, a user in a live room can learn of a time and an online streamer of the livestreaming session in only a scheduling notification. Livestreaming-related information can be pushed to the user only after livestreaming starts, to guide the user to enter the live room for watching.

In a process in which the user in the live room schedules product selling livestreaming of the online streamer, the user cannot perceive a featured product of the online streamer. Consequently, participation enthusiasm of the user cannot be guided. In addition, for a niche online streamer, the user cannot determine information such as cost performance of a product for sale of the online streamer. In addition, for activities such as prize drawing corresponding to the livestreaming, the user cannot learn of activity information in advance during scheduling or participate in the activity in advance either.

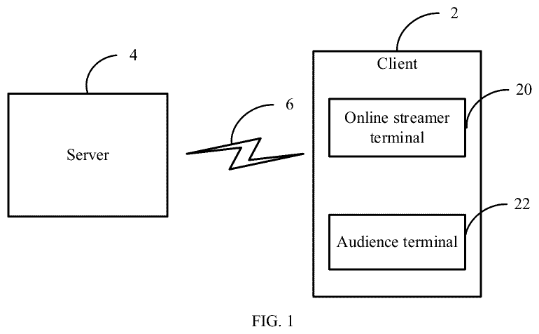

FIG. 1 is a diagram of an architecture of an application environment for implementing the embodiments of this application. This application may be applied to an application environment that includes but is not limited to a client computing device (i.e., client) 2, a server computing device (i.e., server) 4, and a network 6.

The client computing device 2 includes a streamer terminal device 20 associated with an online streamer and an audience terminal device 22 associated with a user watching livestreaming sessions. The streamer terminal device 20 is configured to provide a user (an online streamer) with a scheduling setting page and the like, and receive operations of the user (the online streamer). The audience terminal device 22 is configured to display a page of a live room to a user (an audience in the live room), and display scheduling information of an online streamer in the live room and associated product information and prize pool information. The client 2 may be a terminal device, for example, a personal computer (PC), a mobile phone, a tablet computer, a portable computer, or a wearable device.

The server 4 is configured to provide the client 2 with data and technical support, for example, the associated product information and prize pool information, and corresponding livestreaming scheduling. The server 4 may be a computing device, for example, a rack server, a blade server, a tower server, or a cabinet server, may be an independent server, or may be a server cluster including a plurality of servers.

The network 6 may be a wireless or wired network, for example, an Intranet, the Internet, a global system for mobile communication (GSM), wideband code division multiple access (WCDMA), a 4G network, a 5G network, Bluetooth, or Wi-Fi. The server 4 is communicatively connected to one or more clients 2 by using the network 6, to perform data transmission and exchange.

### Embodiment 1

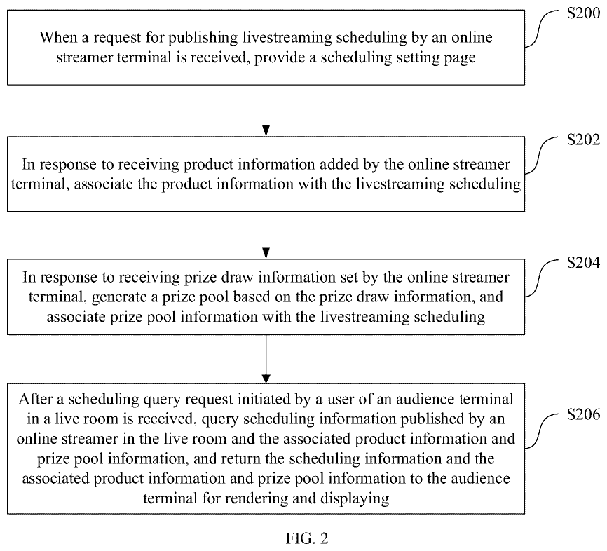

FIG. 2 is a flowchart of a livestreaming scheduling processing method according to a first embodiment of this application. It may be understood that the flowchart in this method embodiment is not used to limit a step execution order. Some steps in the flowchart may alternatively be added or deleted as required. The following describes the method by using a server as an execution body.

The method includes the following steps.

S200: When a request for publishing livestreaming scheduling by an streamer terminal device is received, provide a scheduling setting page for live commerce.

A user of the streamer terminal device (an online streamer in a live room) may send the request in a manner of tapping a livestreaming scheduling publishing button at a live platform or the like. The streamer terminal device sends the request to the server. After the server receives the request, the streamer terminal device is provided with the scheduling setting page for live commerce, and the scheduling setting page is displayed to the user at the streamer terminal device for operation. In this embodiment, in addition to filling the scheduling setting page with scheduling information, the scheduling setting page further includes product adding and prize drawing setting.

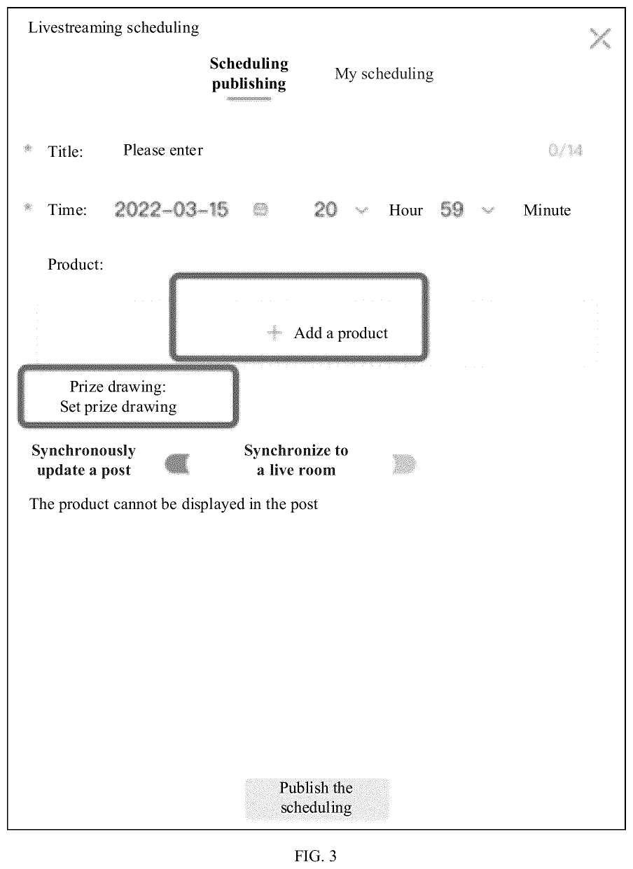

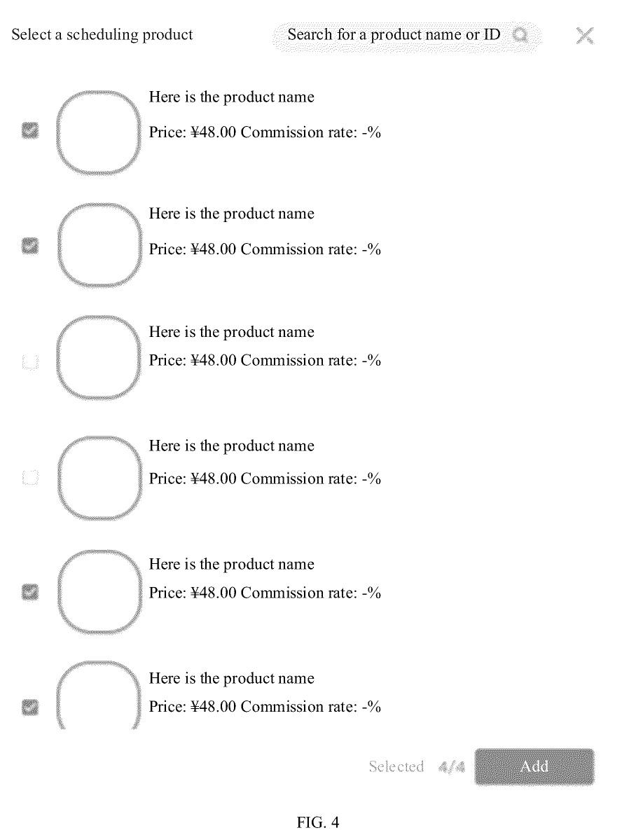

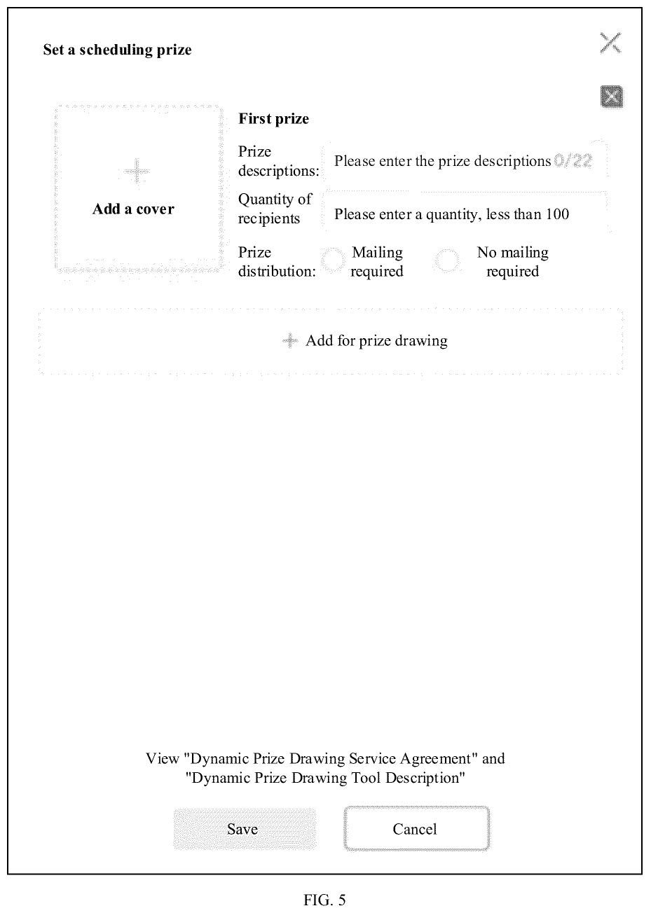

FIG. 3 is a schematic diagram of the scheduling setting page. When the user of the streamer terminal device taps “Add a product”, the user enters a scheduling product selection page. FIG. 4 is a schematic diagram of the scheduling product selection page. When the user of the streamer terminal device taps “Set prize drawing”, the user enters a scheduling prize setting page. FIG. 5 is a schematic diagram of the scheduling prize setting page.

In an optional embodiment, when receiving the request, the server first verifies whether the user of the streamer terminal device has a live commerce permission. Specifically, permission information of the user may be queried based on an ID of the user, to determine whether the user has the live commerce permission. Only when the user of the streamer terminal device has the live commerce permission, the streamer terminal device can be provided with the scheduling setting page carrying product adding and prize drawing setting. Otherwise, only a setting page with fewer functions can be provided (product information cannot be set).

S202: In response to receiving product information added by the online streamer terminal, associate the product information with the livestreaming scheduling.

Specifically, the server first queries inventory information of products for sale of the user of the online streamer terminal, and then provides the streamer terminal device with a product list based on the inventory information. The streamer terminal device displays the product list on the scheduling product selection page. The user of the streamer terminal device can directly check, in the product list, products that need to be displayed in the livestreaming scheduling for this session (as shown in FIG. 4, the checked products may be referred to as hot products).

After addition is complete, the streamer terminal device sends the products checked by the user in the product list and a check order to the server, and sends an association request to the server. Specifically, information about the checked products, for example, a product ID, may be sent in the check order. The server receives the products checked by the user of the streamer terminal device in the product list and the check order.

In a livestreaming scheduling process, to display, to a user in the live room (an audience), the products checked by the online streamer, the server needs to associate the product information with the livestreaming scheduling. In this embodiment, the server records a mapping relationship among a scheduling ID of the livestreaming scheduling, the scheduling information (for example, a title and a livestreaming time), and the information about the checked products (the product ID and the like), and writes the mapping relationship into a database, where the product information is recorded in the check order, to be displayed in the check order after being returned to the audience terminal device.

In another embodiment, in addition to adding, based on the product list, the products associated with the livestreaming scheduling, the user of the streamer terminal device may further set other related information, for example, set a display order of the associated products. Details are not described herein again.

S204: In response to receiving prize drawing information set by the online streamer terminal, generate a prize pool based on the prize drawing information, and associate prize pool information with the livestreaming scheduling.

The user of the streamer terminal device can fill the scheduling prize setting page with prize information of each level, for example, information about a first prize, a second prize, or a third prize. As shown in FIG. 5, a prize description about each level (which may be a copy of a prize of this level), a quantity of recipients, a prize picture, and the like may be set. Specifically, the server may provide some products that are put on sale in advance, so that the user of the streamer terminal device selects some of the products as prizes. Alternatively, the user of the streamer terminal device may directly set a prize for each level and upload a prize picture in a customized manner, or may set the prize information in another manner. Details are not described herein again.

After the user of the streamer terminal device completes setting, the streamer terminal device sends the set prize information to the server. After receiving the prize information, the server generates the prize pool based on the prize drawing information, and returns the prize pool information (ID) to the online streamer terminal. When the user of the streamer terminal device taps “Initiate scheduling”, the association request is sent to the server, and the server associates the prize pool information with the livestreaming scheduling. Specifically, a mapping relationship between a prize pool ID and the scheduling ID is recorded in the database.

In another embodiment, the scheduling setting page may also include setting of another activity other than prize drawing, the user of the streamer terminal device can set information about the activity, and then the server associates the information about the activity (for example, an activity name and a link of an activity description page) with the livestreaming scheduling.

S206: After a scheduling query request initiated by a user of an audience terminal device in a live room is received, query scheduling information published by an online streamer in the live room and the associated product information and prize pool information, and return the scheduling information and the associated product information and prize pool information to the audience terminal device for rendering and displaying.

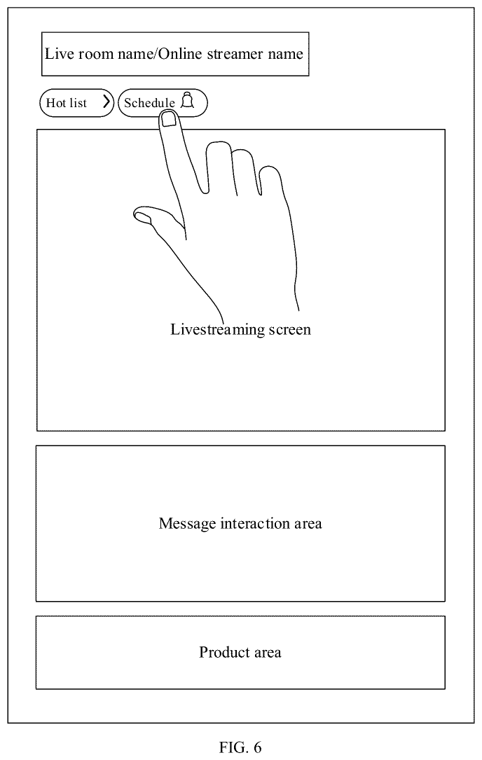

When the user of the audience terminal device enters the live room, the server controls, according to a preset rule, the audience terminal device to display a livestreaming scheduling prompt identifier in the live room. FIG. 6 is a schematic diagram of the livestreaming scheduling prompt identifier. In FIG. 6, a scheduling button under a live room name/an online streamer name is the livestreaming scheduling prompt identifier. The preset rule includes: when livestreaming of a current session is product selling livestreaming, the user of the streamer terminal device has the live commerce permission, and livestreaming scheduling for a future session is already published, controlling the audience terminal device to display the livestreaming scheduling prompt identifier in the live room.

When the user of the audience terminal device taps the livestreaming scheduling prompt identifier or an automatic trigger condition is met (for a specific condition, refer to the following third embodiment), the audience terminal device initiates the scheduling query request to the server. After receiving the scheduling query request, the server queries the scheduling information published by the online streamer in the live room, and returns the scheduling information together with the associated product information and prize pool information to the audience terminal device for rendering and displaying. In addition, when returning a query result to the audience terminal device, in addition to information such as the product ID and the prize pool ID, the server further prepares and returns content such as a product description, a product link, and a prize copy to the audience terminal device for displaying (in a banner frame or a detail page).

It should be noted that each online streamer may set and publish livestreaming scheduling for one or more sessions. However, only livestreaming scheduling for one of the sessions can be finally displayed to the user in the live room. The online streamer may set livestreaming scheduling for a specified session in advance, to display the livestreaming scheduling to the user. Alternatively, livestreaming scheduling for a last session published by the online streamer may be used as the livestreaming scheduling for the specified session specified session, or the like. When the online streamer already publishes livestreaming scheduling for a plurality of sessions, the server queries scheduling information of livestreaming scheduling for a session specified by the online streamer and associated product information and prize pool information, and returns the scheduling information and the associated product information and prize pool information to the audience terminal device for rendering and displaying.

According to the livestreaming scheduling processing method provided in this embodiment, information about a product for sale of the online streamer can be combined with livestreaming session scheduling, and the prize drawing information for scheduling participation can be further added. In this way, related information is prompted to the user in the live room during livestreaming scheduling, thereby effectively promoting an interest of the user in scheduling a livestreaming session of the online streamer, and increasing a user recall rate.

### Embodiment 2

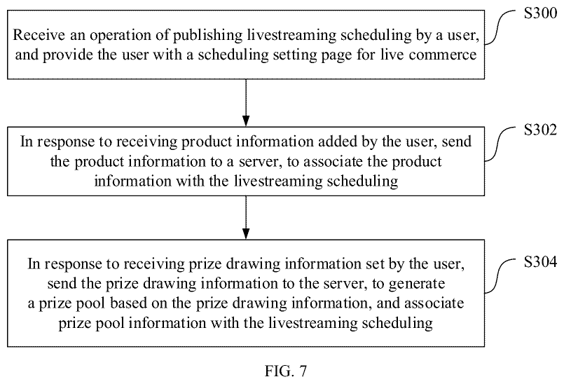

FIG. 7 is a flowchart of a livestreaming scheduling processing method according to a second embodiment of this application. It may be understood that the flowchart in this method embodiment is not used to limit a step execution order. Some steps in the flowchart may alternatively be added or deleted as required. The following describes the method by using an streamer terminal device as an execution body.

The method includes the following steps.

S300: Receive an operation of publishing livestreaming scheduling by a user, and provide the user with a scheduling setting page for live commerce.

A user of the streamer terminal device (an online streamer in a live room) may send, in an operation manner of tapping a livestreaming scheduling publishing button at a live platform or the like, the request for publishing livestreaming scheduling, and the streamer terminal device sends the request to a server. Then, the streamer terminal device provides, based on data support of the server, the user with the scheduling setting page for live commerce for operation by the user. In this embodiment, in addition to filling the scheduling setting page with scheduling information, the scheduling setting page further includes product adding and prize drawing setting.

In an optional embodiment, after receiving the operation of publishing the livestreaming scheduling by the user, the streamer terminal device further needs to send information about the user to the server, so that the server verifies, based on the information about the user, whether the user has a live commerce permission. When a verification result returned by the server indicates that the user has the live commerce permission, the user is provided with the scheduling setting page.

S302: In response to receiving product information added by the user, send the product information to a server, to associate the product information with the livestreaming scheduling.

Specifically, the streamer terminal device requests the server to query inventory information of products for sale of the user, and then provides the user with a product list (on a scheduling product selection page) based on the inventory information returned by the server. The user of the streamer terminal device can directly check, in the product list, products that need to be displayed in the livestreaming scheduling for this session. The streamer terminal device records the products checked by the user in the product list and a check order, sends the products and the check order to the server, and sends an association request to the server. Specifically, information about the checked products, for example, a product ID, may be sent in the check order. The server records a mapping relationship among a scheduling ID of the livestreaming scheduling, the scheduling information (for example, a title and a livestreaming time), and the information about the checked products (the product ID and the like), and writes the mapping relationship into a database, where the product information is recorded in the check order, to be displayed in the check order after being returned to an audience terminal device.

In another embodiment, in addition to adding, based on the product list, the products associated with the livestreaming scheduling, the user of the streamer terminal device may further set other related information, for example, set a display order of the associated products. Details are not described herein again.

S304: In response to receiving prize drawing information set by the user, send the prize drawing information to the server, to generate a prize pool based on the prize drawing information, and associate prize pool information with the livestreaming scheduling.

The user of the streamer terminal device can fill the scheduling prize setting page with prize information of each level, for example, information about a first prize, a second prize, or a third prize. After the user completes setting, the streamer terminal device sends the set prize information to the server. After receiving the prize information, the server generates the prize pool based on the prize drawing information, and returns the prize pool information (ID) to the online streamer terminal. When the user of the streamer terminal device taps “Initiate scheduling”, the association request is sent to the server, and the server associates the prize pool information with the livestreaming scheduling. Specifically, a mapping relationship between a prize pool ID and the scheduling ID is recorded in the database.

In another embodiment, the scheduling setting page may also include setting of another activity other than prize drawing, the user of the streamer terminal device can set information about the activity, and then the server associates the information about the activity (for example, an activity name and a link of an activity description page) with the livestreaming scheduling.

According to the livestreaming scheduling processing method provided in this embodiment, information about a product for sale of the online streamer can be combined with livestreaming session scheduling, and the prize drawing information for scheduling participation can be further added. In this way, related information is prompted to the user in the live room during livestreaming scheduling, thereby effectively promoting an interest of the user in scheduling a livestreaming session of the online streamer, and increasing a user recall rate.

### Embodiment 3

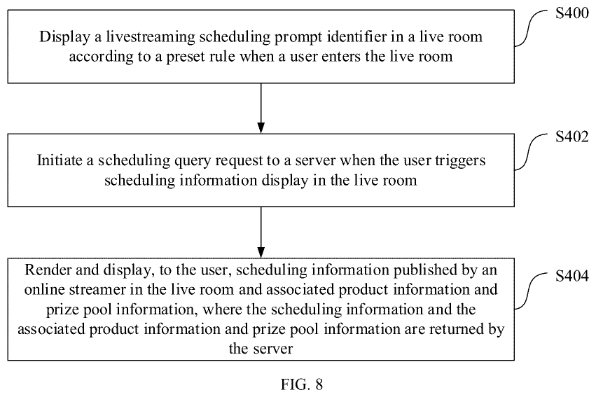

FIG. 8 is a flowchart of a livestreaming scheduling processing method according to a third embodiment of this application. It may be understood that the flowchart in this method embodiment is not used to limit a step execution order. Some steps in the flowchart may alternatively be added or deleted as required. The following describes the method by using an audience terminal device as an execution body.

The method includes the following steps.

S400: Display a livestreaming scheduling prompt identifier in a live room according to a preset rule when a user enters the live room.

When the user of the audience terminal device enters the live room, the audience terminal device displays the livestreaming scheduling prompt identifier (as shown in FIG. 6) in the live room. The preset rule includes: when livestreaming of a current session is product selling livestreaming, an online streamer in the live room has a live commerce permission, and livestreaming scheduling for a future session is already published, displaying the livestreaming scheduling prompt identifier in the live room. Otherwise, the livestreaming scheduling prompt identifier is not displayed in the live room, that is, the user cannot perform the livestreaming scheduling.

S402: Initiate a scheduling query request to a server when the user triggers scheduling information display in the live room.

The user may trigger the scheduling information display (which refers to opening the following banner frame) in the live room by performing an operation of tapping the livestreaming scheduling prompt identifier (as shown in FIG. 6), and then the audience terminal device initiates the scheduling query request to the server after receiving the operation of tapping the livestreaming scheduling prompt identifier by the user.

It should be noted that the triggering scheduling information display further includes the following automatic trigger scenarios:
the user enters the live room for the first time in each session of livestreaming;
the user watches for preset duration (for example, two minutes or five minutes) for the first time in each session of livestreaming;
the user follows the online streamer in the live room for the first time in each session of livestreaming;
the user forwards the live room for the first time in each session of livestreaming; or
the livestreaming scheduling prompt identifier appears in the live room in real time during each session of livestreaming.

When any of the foregoing conditions is met, the audience terminal device automatically triggers the scheduling information display, and initiates the scheduling query request to the server.

In addition, when the scheduling information display has been triggered and the previous display does not exceed a preset time limit (for example, one minute), the scheduling information display is not automatically triggered again (if the trigger condition is met again, this trigger is invalid, except for triggering actively operated by the user). In addition, if the user completes scheduling, the scheduling information display is not automatically triggered again.

S404: Render and display, to the user, scheduling information published by an online streamer in the live room and associated product information and prize pool information, where the scheduling information and the associated product information and prize pool information are returned by the server.

After receiving the scheduling query request, the server queries the scheduling information published by the online streamer in the live room, and returns the scheduling information together with the associated product information and prize pool information to the audience terminal device for rendering and displaying. After receiving the scheduling information and the associated product information and prize pool information, the audience terminal device renders and displays the scheduling information and the associated product information and prize pool information to the user.

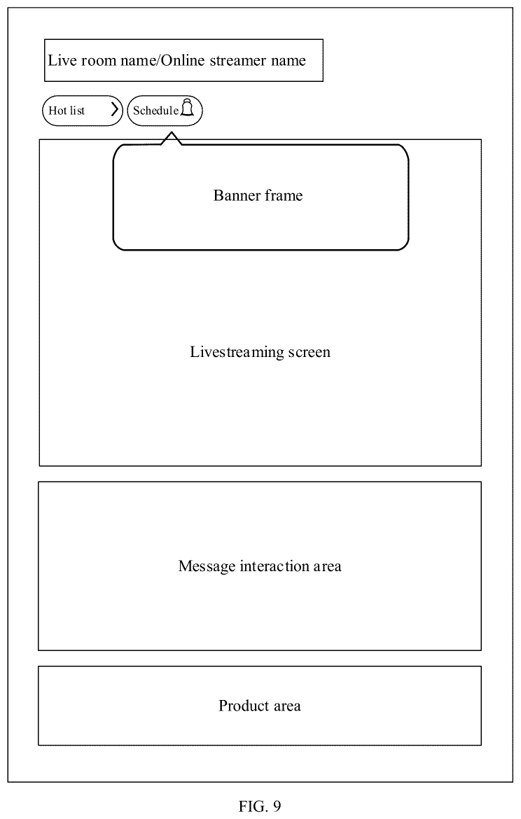

In this embodiment, the rendering and displaying includes: rendering and displaying the scheduling information in the live room by using a banner frame, and displaying a corresponding prompt copy based on the associated product information and prize pool information. FIG. 9 is a schematic diagram of the live room in which the banner frame is opened. When the user taps the livestreaming scheduling prompt identifier or the automatic trigger condition is met, the audience terminal device opens the banner frame based on information queried by the server, to display, in the banner frame, the scheduling information published by the online streamer in the live room and the prompt copy corresponding to each of the associated product information and prize pool information. The banner frame is implemented at an audience terminal device with an iOS or Android system by using a pure client component.

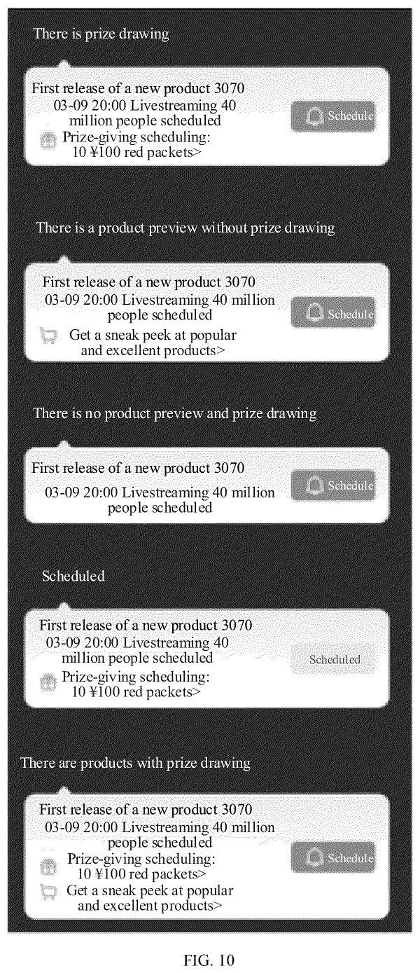

FIG. 10 is a schematic diagram of display content of several banner frames in different cases. For example, when the livestreaming scheduling is not associated with the product information or the prize pool information, only the scheduling information is displayed in the banner frame. When the livestreaming scheduling is not associated with the product information but is associated with the prize pool information, the scheduling information and the prompt copy (which may be a copy corresponding to a prize of a first prize, for example, “Prize-giving scheduling: 10¥100 red packets”) corresponding to the prize pool information are displayed in the banner frame. When the livestreaming scheduling is not associated with the prize pool information but is associated with the product information, the scheduling information and the prompt copy (for example, “Get a sneak peek at popular and excellent products”) corresponding to the product information are displayed in the banner frame. When the livestreaming scheduling is associated with the product information and the prize pool information, the scheduling information and the prompt copies corresponding to the product information and the prize pool information are simultaneously displayed in the banner frame.

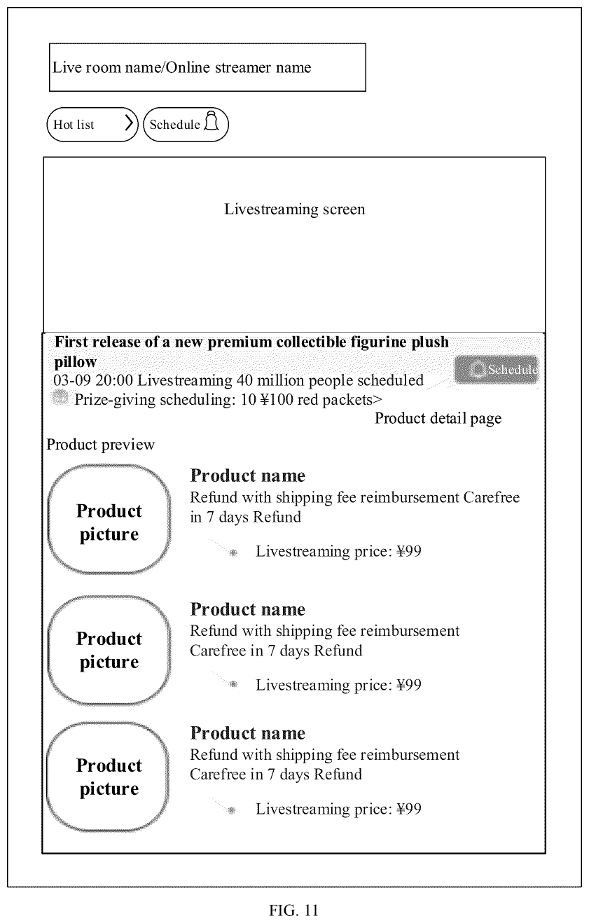

The prompt copy of the product information or the prize pool information in the banner frame may alternatively be an entrance of a corresponding detail page. When an operation of tapping the prompt copy of the product information or the prize pool information by the user is received, the audience terminal device wakes up a window container in the live room, and renders an H5 page, to display a detail page corresponding to the product information or the prize pool information. FIG. 11 is a schematic diagram of the detail page of the product information. In FIG. 11, the detail page of the product information is overlaid on an original page of the live room, to display, to the user, detail information of various products associated with the livestreaming scheduling for this session.

After the banner frame is opened, if the user does not continue an operation, the banner frame automatically restores to a collapsed state after a preset time period (for example, ten seconds).

In addition, the banner frame and the detail page each may further include a scheduling button. After the user taps the scheduling button, livestreaming scheduling for this session can be completed. In this case, the server records a livestreaming scheduling behavior of the user for this session, and reminds the user before livestreaming of this session starts. In addition, when the livestreaming of this session is associated with the prize pool information, information about the user is further put into a prize pool for prize drawing.

According to the livestreaming scheduling processing method provided in this embodiment, information about a product for sale of the online streamer can be combined with livestreaming session scheduling, and the prize drawing information for scheduling participation can be further added. In this way, related information is prompted to the user in the live room during livestreaming scheduling, and after the user in the live room completes scheduling, the information about the user is added to the prize pool set by the online streamer for prize drawing, thereby effectively promoting an interest of the user in scheduling a livestreaming session of the online streamer, and increasing a user recall rate.

### Embodiment 4

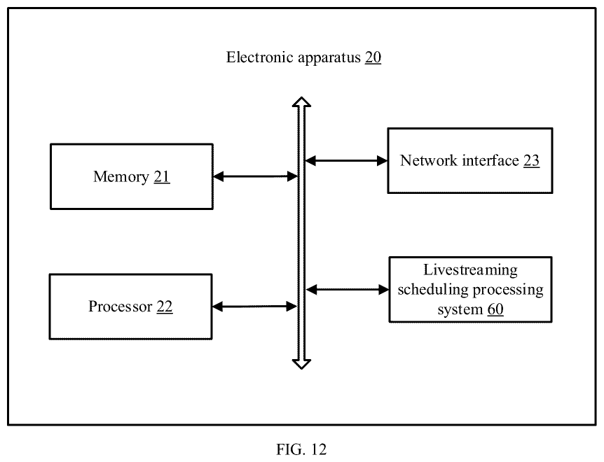

FIG. 12 is a schematic diagram of a hardware architecture of an electronic apparatus 20 according to a fourth embodiment of this application. In this embodiment, the electronic apparatus 20 may include but is not limited to a memory 21, a processor 22, and a network interface 23 that may be communicatively connected to each other by using a system bus. It should be noted that FIG. 12 merely shows the electronic apparatus 20 with the components 21 to 23. However, it should be understood that implementation of all the shown components is not required, and more or fewer components may alternatively be implemented. In this embodiment, the electronic apparatus 20 may be the client (the streamer terminal device or the audience terminal device), or may be the server.

The memory 21 includes at least one type of readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 21 may be an internal storage unit of the electronic apparatus 20, for example, a hard disk or a memory of the electronic apparatus 20. In some other embodiments, the memory 21 may alternatively be an external storage device of the electronic apparatus 20, for example, a removable hard disk, a smart media card (SMC), a secure digital (SD) card, or a flash card that is disposed on the electronic apparatus 20. Certainly, the memory 21 may alternatively include both an internal storage unit of the electronic apparatus 20 and an external storage device of the electronic apparatus 20. In this embodiment, the memory 21 is usually configured to store an operating system and various types of application software that are installed in the electronic apparatus 20, for example, program code of a livestreaming scheduling processing system 60. In addition, the memory 21 may be further configured to temporarily store various types of data that have been output or are to be output.

The processor 22 may be a central processing unit (CPU), a controller, a microcontroller, a microprocessor, or another data processing chip in some embodiments. The processor 22 is usually configured to control an overall operation of the electronic apparatus 20. In this embodiment, the processor 22 is configured to run program code stored in the memory 21 or process data, for example, run the livestreaming scheduling processing system 60.

The network interface 23 may include a wireless network interface or a wired network interface, and the network interface 23 is usually configured to establish a communication connection between the electronic apparatus 20 and another electronic device.

### Embodiment 5

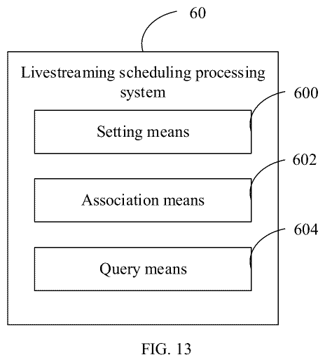

FIG. 13 is a schematic diagram of means of a livestreaming scheduling processing system 60 according to a fifth embodiment of this application. The livestreaming scheduling processing system 60 is applied to a server and may be divided into one or more program means. The one or more program means are stored in a storage medium and executed by one or more processors, to complete this embodiment of this application. The program means in this embodiment of this application is a series of computer program instruction segments that can be used to complete a specific function. The following describes in detail a function of each program means in this embodiment.

In this embodiment, the livestreaming scheduling processing system 60 includes:
a setting means 600, configured to: when a request for publishing livestreaming scheduling by an streamer terminal device is received, provide a scheduling setting page for live commerce, where the scheduling setting page includes product adding and prize drawing setting;
an association means 602, configured to: in response to receiving product information added by the online streamer terminal, associate the product information with the livestreaming scheduling, where
the association means 602 is further configured to: in response to receiving prize drawing information set by the online streamer terminal, generate a prize pool based on the prize drawing information, and associate prize pool information with the livestreaming scheduling; and
a query means 604, configured to: after a scheduling query request initiated by a user of an audience terminal device in a live room is received, query scheduling information published by an online streamer in the live room and the associated product information and prize pool information, and return the scheduling information and the associated product information and prize pool information to the audience terminal device for rendering and displaying.

For specific functions of the foregoing means, refer to descriptions in the first embodiment. Details are not described herein again.

In addition, when the livestreaming scheduling processing system 60 is applied to the streamer terminal device or the audience terminal device, functions corresponding to the livestreaming scheduling processing method in the foregoing second embodiment or the foregoing third embodiment may also be implemented by using the one or more program means. Details are not described herein again.

### Embodiment 6

This application further provides another implementation, that is, provides a computer-readable storage medium. The computer-readable storage medium stores a livestreaming scheduling processing program, and the livestreaming scheduling processing program may be executed by at least one processor, to enable the at least one processor to perform the steps of the foregoing livestreaming scheduling processing method.

It should be noted that in this specification, the term “include”, “comprise”, or any other variant thereof is intended to cover non-exclusive inclusion, so that a process, method, article, or apparatus that includes a series of elements includes those elements and other elements that are not explicitly listed or elements inherent to the process, method, article, or apparatus. In the absence of more restrictions, the element defined with the statement “includes one . . . ” does not exclude the existence of another identical element in the process, method, article, or apparatus that includes the element.

The serial numbers of the foregoing embodiments of this application are merely for illustrative purposes, and are not intended to indicate priorities of the embodiments.

Clearly, a person skilled in the art should understand that the foregoing means or steps in the embodiments of this application may be implemented by using a general computing apparatus. The means or steps may be integrated into a single computing apparatus or distributed in a network including a plurality of computing apparatuses. Optionally, the means or steps may be implemented by using program code that can be executed by the computing apparatus. Therefore, the means or steps may be stored in a storage apparatus for execution by the computing apparatus. In addition, in some cases, the shown or described steps may be performed in an order different from the order herein. Alternatively, the means or steps are separately made into integrated circuit means, or a plurality of means or steps in the means or steps are made into a single integrated circuit means for implementation. In this way, a combination of any specific hardware and software is not limited in the embodiments of this application.

The foregoing descriptions are merely embodiments in the embodiments of this application, and are not intended to limit the patent scope of the embodiments of this application. Any equivalent structure or equivalent procedure change that is made by using the content of the specification and the accompanying drawings of the embodiments of this application or that is directly or indirectly applied to other related technical fields shall also fall within the patent protection scope of the embodiments of this application.

What is claimed is:

1. A method of scheduling livestreaming sessions and presenting scheduling information, applied to a server computing system, and comprising:
in response to receiving a request for scheduling a livestreaming session sent by a streamer terminal device associated with an online streamer, causing to display a scheduling setting page on the streamer terminal device;
receiving information associated with the livestreaming session to be produced by the online streamer via the scheduling setting page;
generating a scheduling identifier (ID) corresponding to scheduling the livestreaming session, and associating the information received via the scheduling setting page with the scheduling ID;
causing to display an interface element configured to prompt a query for livestreaming scheduling information on an audience terminal device in response to determining that the audience terminal device enters a live room associated with the online streamer, wherein a scheduling query request is generated and transmitted by the audience terminal device in response to receiving a user input via the interface element; and
in response to receiving the scheduling query request from the audience terminal device, querying scheduling information published by the online streamer and returning the scheduling information to the audience terminal device for rendering and displaying.

2. The method according to claim 1, wherein the scheduling setting page comprises interface elements configured to add products or set a prize draw associated with the livestreaming session to be produced by the online streamer.

3. The method according to claim 2, further comprising:
recording a mapping relationship among the scheduling ID, the scheduling information, and information about the products, and writing the mapping relationship into a database.

4. The method according to claim 2, further comprising:
in response to receiving prize draw information set by the streamer terminal device, generating a prize pool based on the prize draw information and generating a prize pool identifier (ID) corresponding to the prize pool;
recording a mapping relationship between the prize pool ID and the scheduling ID into a database.

5. The method according to claim 1, wherein the querying scheduling information published by the online streamer further comprises:
in response to determining that the online streamer has already published scheduling for a plurality of livestreaming sessions, querying scheduling information of a session among the plurality of livestreaming sessions that is specified by the online streamer and other information associated with the session.

6. A method of presenting livestreaming scheduling information, applied to an audience terminal device, comprising:
displaying an interface element configured to prompt a query for scheduling information published by an online streamer in response to determining that the audience terminal device enters a live room associated with the online streamer, wherein the online streamer has scheduled a livestreaming session via a scheduling setting page;
generating and transmitting a scheduling query request to a server computing system in response to receiving a user input on the interface element;
receiving the scheduling information and other information associated with the livestreaming session to be produced by the online streamer; and
rendering and displaying the scheduling information and other information associated with the livestreaming session on the audience terminal device.

7. The method according to claim 6, wherein the receiving a user input on the interface element comprises receiving an operation of tapping the interface element by the user.

8. The method according to claim 6, further comprising:
automatically generating the scheduling query request based on a predetermined rule.

9. The method according to claim 8, wherein the predetermined rule comprises:
entering the live room for a first time by the audience terminal device;
watching for a preset duration for a first time in each livestreaming session by a user associated with the audience terminal device;
following the online streamer in the live room for a first time in each livestreaming session by the user associated with the audience terminal device;
forwarding the live room for a first time in each livestreaming session by the user associated with the audience terminal device; and
the interface element appearing in the live room in real time during each livestreaming session.

10. The method according to claim 6, wherein the rendering and displaying comprises:
rendering and displaying the scheduling information and other information associated with the scheduled livestreaming session by using a banner frame.

11. The method according to claim 6, wherein the scheduling setting page comprises interface elements configured to add products or set a prize draw associated with the livestreaming session to be produced by the online streamer.

12. The method according to claim 11, wherein the other information associated with the livestreaming session comprises product information added by the online streamer and prize draw information set by the online streamer via the scheduling setting page.

13. The method according to claim 12, further comprising:
rendering and displaying the scheduling information, the product information, and the prize draw information by using a banner frame; and
waking up a window container in the live room, rendering a HTML5 page to display a detail page corresponding to the product information or the prize drawing information in response to receiving a user input on the product information or the prize drawing information displayed in the banner frame.

14. A server computing system of scheduling livestreaming sessions and presenting scheduling information, comprising:
at least one processor; and
at least one memory communicatively coupled to the at least one processor and comprising computer-readable instructions that upon execution by the at least one processor cause the at least one processor to perform operations comprising:
in response to receiving a request for scheduling a livestreaming session sent by a streamer terminal device associated with an online streamer, causing to display a scheduling setting page on the streamer terminal device;
receiving information associated with the livestreaming session to be produced by the online streamer via the scheduling setting page;
generating a scheduling identifier (ID) corresponding to scheduling the livestreaming session, and associating the information received via the scheduling setting page with the scheduling ID;
causing to display an interface element configured to prompt a query for livestreaming scheduling information on an audience terminal device in response to determining that the audience terminal device enters a live room associated with the online streamer, wherein a scheduling query request is generated and transmitted by the audience terminal device in response to receiving a user input via the interface element; and
in response to receiving the scheduling query request from the audience terminal device, querying scheduling information published by the online streamer and returning the scheduling information to the audience terminal device for rendering and displaying.

15. The server computing system according to claim 14, wherein the scheduling setting page comprises interface elements configured to add products or set a prize draw associated with the livestreaming session to be produced by the online streamer.

16. The server computing system according to claim 15, the operations further comprising:
recording a mapping relationship among the scheduling ID, the scheduling information, and information about the products, and writing the mapping relationship into a database.

17. The server computing system according to claim 15, the operations further comprising:
in response to receiving prize draw information set by the streamer terminal device, generating a prize pool based on the prize draw information and generating a prize pool identifier (ID) corresponding to the prize pool;
recording a mapping relationship between the prize pool ID and the scheduling ID into a database.

18. The server computing system according to claim 14, wherein the querying scheduling information published by the online streamer further comprises:
in response to determining that the online streamer has already published scheduling for a plurality of livestreaming sessions, querying scheduling information of a session among the plurality of livestreaming sessions that is specified by the online streamer and other information associated with the session.
